(19) United States
(12) Patent Application Publication
(10) Pub. No.: US 2012/0182321 A1
(43) Pub. Date: Jul. 19, 2012

(54) IMAGE CONVERTER, IMAGE CONVERSION METHOD, PROGRAM AND ELECTRONIC EQUIPMENT

(75) Inventors: Masato Kondo, Kanagawa (JP); Shinsuke Koyama, Chiba (JP)

(73) Assignee: Sony Corporation, Tokyo (JP)

(21) Appl. No.: 13/302,641

(22) Filed: Nov. 22, 2011

(30) Foreign Application Priority Data
Jan. 19, 2011 (JP) 2011-008598

(51) Int. Cl. G09G 5/00

(52) U.S. Cl. 345/660

(57) ABSTRACT

Disclosed herein is an image converter including an acquisition section, a storage section, and a conversion section. The acquisition section is adapted to acquire pixel data of a plurality of pixels that are defined in a matrix form in an image. The storage section is adapted to store the acquired pixel data. The conversion section is adapted to enlarge or reduce an acquired input image into an output image by increasing or reducing the number of pixels making up the image using the pixel data stored in the storage section. The acquisition section reads pixel data of a plurality of pixels included in each row of the input image on a plurality of separate occasions. The conversion section performs enlarging or reducing processing to increase or reduce the number of pixels in the order in which the pixels are read into the storage section.

### BACKGROUND

The present disclosure relates to an image converter, image conversion method, program and electronic equipment for enlarging or reducing an image.

An image converter adapted to enlarge or reduce an image is used, for example, in electronic equipment such as television broadcasting receiver.

In Japanese Patent Laid-Open No. 2006-60414, for example, a television broadcasting receiver enlarges or reduces an image obtained by receiving digital broadcasting, thus displaying the image as a main screen or subscreen on its display section.

### SUMMARY

Incidentally, an image converter used in such a piece of electronic equipment commonly has a line memory and vertical and horizontal interpolation filters.

Then, the image converter reads an image into its line memory on a line-by-line (row-by-row) basis.

The vertical and horizontal interpolation filters enlarge or reduce the line read into the line memory.

More specifically, for example, the image converter successively reads a plurality of pixel data making up the image from an external memory device in the direction in which the image is raster scanned.

This allows for the line memory to hold a plurality of rows of pixel data necessary for enlarging or reducing.

The vertical and horizontal interpolation filters proceed with enlarging or reducing of the plurality of rows of pixel data stored in the line memory.

This allows for the image to be enlarged or reduced.

For example, a row of pixel data is added between two adjacent rows of an image stored in the external storage device, thus generating an enlarged image.

On the other hand, for example, two adjacent rows of an image stored in the external storage device are converted into a row of pixel data, thus generating a reduced image.

The pixel data generated by the conversion is output, for example, from the image converter to the external storage device, and then from the external storage device to the display section.

As described above, an image converter used in a piece of electronic equipment commonly processes the image to be converted successively in the raster scan direction.

Therefore, it is necessary for the image converter to use a line memory capable of storing as many lines of pixel data as the number of taps of the vertical filter for the image to be processed.

This has led to increasingly large image sizes to be processed because of the growth in the number of pixels making up digital broadcasting images. As a result, it is necessary for the image converter or electronic equipment to use a large-capacity line memory appropriate to the input image size.

For example, each time the broadcasting standard is changed to offer a higher image quality, it is necessary for the electronic equipment to change the storage capacity of the line memory to that appropriate to the image size defined in the new standard.

As described above, what is sought after in such an image converter is to eliminate the limitations on the image size that can be processed resulting from the storage capacity of a storage section for conversion.

An image converter according to a first mode of the present disclosure includes an acquisition section adapted to acquire pixel data of a plurality of pixels that are defined in a matrix form in an image, a storage section adapted to store the acquired pixel data, and a conversion section adapted to enlarge or reduce an acquired input image into an output image by increasing or reducing the number of pixels making up the image using the pixel data stored in the storage section. The acquisition section reads pixel data of a plurality of pixels included in each row of the input image on a plurality of separate occasions. The conversion section performs enlarging or reducing processing to increase or reduce the number of pixels in the order in which the pixels are read into the storage section.

In the present disclosure, pixel data of a plurality of pixels included in each row of the input image is read on a plurality of separate occasions.

This eliminates the need to use a storage section capable of storing all the pixel data in each row of the input image.

According to a second mode, there is provided an image conversion method of an image converter. The image converter includes an acquisition section adapted to acquire pixel data of a plurality of pixels that are defined in a matrix form in an image, a storage section adapted to store the acquired pixel data, and a conversion section adapted to enlarge or reduce an acquired input image into an output image by increasing or reducing the number of pixels making up the image using the pixel data stored in the storage section. In the image conversion method, the acquisition section is adapted to read pixel data of a plurality of pixels included in each row of the input image on a plurality of separate occasions. The conversion section is adapted to perform enlarging or reducing processing to increase or reduce the number of pixels in the order in which the pixels are read into the storage section.

A program according to a third mode causes a computer to serve as a control section of an image converter, the image converter including an acquisition section adapted to acquire pixel data of a plurality of pixels that are defined in a matrix form in an image, a storage section adapted to store the acquired pixel data, and a conversion section adapted to enlarge or reduce an acquired input image into an output image by increasing or reducing the number of pixels making up the image using the pixel data stored in the storage section, the control section adapted to control the acquisition section and conversion section. The program causes the computer to determine the number of divisions of an input image and a plurality of areas into which the input image is divided by the number of divisions, cause the acquisition section to read pixel data of a plurality of pixels included in each row of the input image on a plurality of separate occasions, and cause the conversion section to perform enlarging or reducing processing to increase or reduce the number of pixels in the order in which the pixels are read into the storage section in such a manner that enlarging or reducing processing is repeated in the plurality of divided areas as many times as the number of divisions.

Electronic equipment according to a fourth mode includes an external memory adapted to store digital image data having pixel data of a plurality of pixels defined in a matrix form in an image, and an image conversion section adapted to read a plurality of pixel data from the external memory for image enlarging or reducing. The image conversion section includes an acquisition section adapted to acquire pixel data from the external memory, a storage section adapted to store the acquired pixel data, and a conversion section adapted to enlarge or reduce an acquired input image into an output image by increasing or reducing the number of pixels making up the image using the pixel data stored in the storage section. The acquisition section reads pixel data of a plurality of pixels included in each row of the input image on a plurality of separate occasions. The conversion section performs enlarging or reducing processing to increase or reduce the number of pixels in the order in which the pixels are read into the storage section.

The present disclosure eliminates the limitations on the image size that can be processed resulting from the storage capacity of the storage section.

### BRIEF DESCRIPTION OF THE DRAWINGS

FIG. 1 is a schematic block diagram illustrating an image converter according to a first embodiment of the present disclosure;

FIG. 2 is a block diagram of an ordinary enlargement/reduction section;

FIG. 3 is a block diagram of the enlargement/reduction section shown in FIG. 1;

FIGS. 4A to 4C are explanatory diagrams illustrating an example of a plurality of divided areas having overlapping areas for an image subject to enlarging or reducing;

FIGS. 5A and 5B are explanatory diagrams of masking performed by a boundary processing section shown in FIG. 3;

FIG. 6 is a sequence diagram illustrating an example of multi-pass scaling performed by an enlargement/reduction section;

FIGS. 7A and 7B are diagrams describing the relationship between a line of an input image before enlarging or reducing and a line of an output image after enlarging or reducing;

FIGS. 8A to 8D are diagrams describing the relationship between the divided areas of the input image and those of the output image;

FIG. 9 is an explanatory diagram of parameters calculated by a control section shown in FIG. 1 during enlarging or reducing;

FIG. 10 is a schematic block diagram of a television broadcasting receiver according to a second embodiment of the present disclosure; and

FIG. 11 is a block diagram illustrating an example of a reception circuit of the television broadcasting receiver shown in FIG. 10.

### DETAILED DESCRIPTION OF THE PREFERRED EMBODIMENTS

A description will be given below of the embodiments of the present disclosure with reference to the accompanying drawings. The description will be given in the following order:

### 1. First Embodiment (example of an image converter)

### 2. Second Embodiment (example of an electronic equipment)

### 1. First Embodiment

### [Configuration of Image Converter]

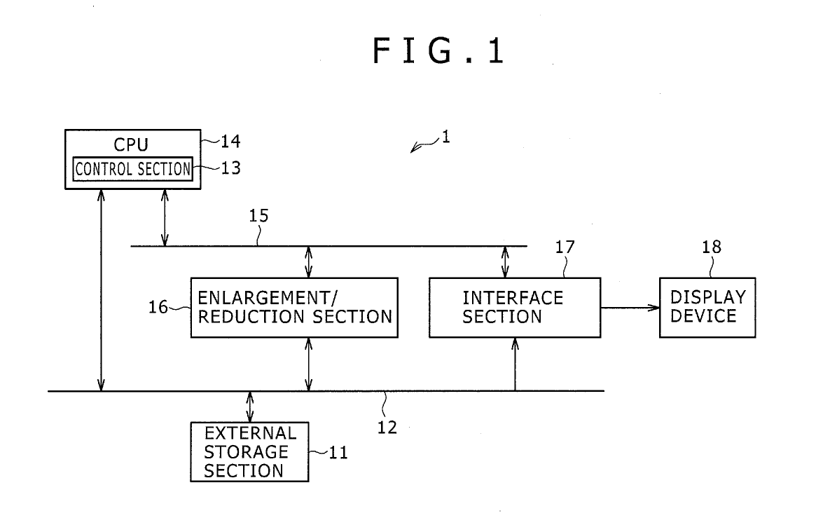

FIG. 1 is a schematic block diagram illustrating an image converter according to a first embodiment of the present disclosure.

An image converter 1 shown in FIG. 1 includes an external storage section 11, data bus 12, CPU (Central Processing Unit) 14 serving as a control section 13, control bus 15, enlargement/reduction section 16 and interface section 17.

The image converter 1 enlarges or reduces an image of the digital image data stored in the external storage section 11, outputting the resultant image to a display device 18 connected to the image converter 1.

The display device 18 displays the image enlarged or reduced based on the supplied digital image data.

An image of digital image data before enlarging or reducing will be hereinafter referred to as an input image, and an image of digital image data after enlarging or reducing as an output image.

The external storage section 11 stores digital image data input to and output from the image converter 1.

The same device 11 is, for example, a DRAM (Dynamic Random Access Memory).

A DRAM has, for example, a DMA (Direct Memory Access) mode that allows for the enlargement/reduction section 16 to access the DRAM without going through the CPU 14.

In addition to the above, the external storage section 11 may include at least one storage member selected from among a harddisk drive, flash memory and RAM (Random Access Memory).

Further, the external storage section 11 may have a connector portion connected to the data bus 12, and the same device 11 may be attachable to and detachable from the connector portion.

Digital image data stored in the external storage section 11 includes a plurality of pixel data.

The plurality of pixel data are defined in a matrix form in an image.

The pixel data has, for example, RGB (Red, Green and Blue) data for the associated pixel.

The pixel data may be complementary color data or monotone data rather than primary color data.

The digital image data may be stored in the external storage section 11 pixel by pixel in a decompressed form or in chunks with each chunk including data for a plurality of pixels.

Digital image data stored in the external storage section 11 is acceptable so long as the data is accessible on a pixel data-by-pixel data basis.

The data bus 12 is connected to the external storage section 11, CPU 14, enlargement/reduction section 16 and interface section 17.

Each of the CPU 14, enlargement/reduction section 16 and interface section 17 accesses the external storage section 11 via the data bus 12.

The ordinary data bus 12 has address lines, data lines and control lines. The address lines are used to specify the access destination in the external storage section 11. The data lines are used to input or output access-related data. The control lines are used, for example, to control the read and write operations.

The data bus 12 may be a serial data bus rather than a parallel data bus.

The CPU 14 includes one or a plurality of arithmetic processors each incorporating a processing core.

The CPU 14 reads a program from the external storage section 11 for execution by the processing cores, thus serving as the control section 13 of the image converter 1.

The program executed by the CPU 14 may be preinstalled in the external storage section 11 before shipment of the image converter 1. Alternatively, the program may be installed in the external storage section 11 after shipment thereof.

The program installed after shipment may be downloaded via a network such as the Internet or obtained from a recording media such as CD-ROM (Compact Disc Read Only Memory).

The control bus 15 is connected to the CPU 14, enlargement/reduction section 16 and interface section 17.

The control section 13 controls the enlargement/reduction section 16 and interface section 17 via the control bus 15.

When enlarging or reducing an image, the control section 13 sets, for example, enlarging or reducing parameters of the input image, stored in the external storage section 11, in the enlargement/reduction section 16.

The same section 13 causes the enlargement/reduction section 16 to enlarge or reduce the input image.

The control section 13 causes the interface section 17 to output the digital image data of an output image produced by the enlarging or reducing processing.

The enlargement/reduction section 16 enlarges or reduces the input image.

The same section 16 reads the digital image data of the input image from the external storage section 11 and increases or reduces the number of pixels defining the image based on the set parameters when instructed to do so by the control section 13.

At this time, the enlargement/reduction section 16 enlarges or reduces the image in the area specified by the parameters one row at a time in the raster scan direction without determining whether the image to be processed is the whole or part of the input image.

This produces an output image with the number of pixels converted from the defined number of pixels of the input image.

The enlargement/reduction section 16 writes the digital image data of the output image, produced based on the specified parameters, to the external storage section 11.

This allows for the digital image data of the output image to be stored in the external storage section 11.

The interface section 17 outputs the enlarged or reduced output image externally from the image converter 1.

The same section 17 reads the digital image data of the output image from the external storage section 11 and outputs the data externally from the image converter 1 when instructed to do so by the control section 13.

The interface section 17 is connected, for example, to the display device 18.

The display device 18 has a display section that includes a liquid crystal display, organic EL (Electro Luminescence) display or CRT (Cathode Ray Tube) monitor.

The display device 18 displays the image, supplied based on the image data, on the display section.

Among images displayed on the display device 18 are frame images of broadcasting moving image and still image.

Further, the image displayed on the display section may be an image including, for example, a frame such as a web page. Still further, a moving image may be included in a web page.

### [Description of Enlarging or Reducing Processing]

The control section 13 sets various enlarging or reducing parameters in the enlargement/reduction section 16 shown in FIG. 1.

The enlargement/reduction section 16 enlarges or reduces the area of the image (partial image) specified by the parameters.

The enlargement/reduction section 16 shown in FIG. 1 reads the image to be processed one row at a time in the raster scan direction (same direction as the row direction of the image) during enlarging or reducing as does an ordinary enlargement/reduction section 100.

Further, when multi-pass scaling is performed that is designed to divide an input image into a plurality of areas and process each divided area as described later, the enlargement/reduction section 16 enlarges or reduces the partial image in each divided area.

The enlargement/reduction section 16 repeats the enlarging or reducing of the partial images as many times as the number of divisions of the image.

It should be noted that the enlargement/reduction section 16 reads the partial image in each divided area one row at a time in the raster scan direction during the enlarging or reducing of each of the divided areas as does the ordinary enlargement/reduction section 100 for an entire image.

### [Description of Ordinary Enlarging or Reducing Processing]

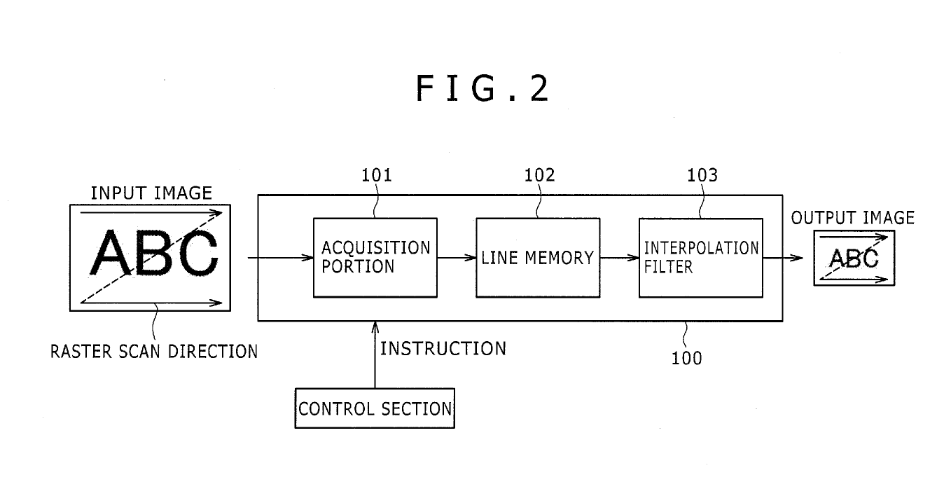

FIG. 2 is a block diagram illustrating the configuration of the ordinary enlargement/reduction section 100 different from the enlargement/reduction section 16 shown in FIG. 1.

The ordinary enlargement/reduction section 100 includes, for example, an acquisition portion 101, line memory 102 and interpolation filter 103.

Further, FIG. 2 illustrates an input image on the left of the ordinary enlargement/reduction section 100 and an output image on the right thereof to describe ordinary enlarging or reducing processing.

In ordinary enlarging or reducing processing, the acquisition portion 101 reads the pixel data of the input image successively from the external storage section 11 one row at a time as illustrated by an arrow line in the input image in FIG. 2.

The acquisition portion 101 reads a plurality of pixel data of the input image successively from top one row at a time in the raster scan direction.

The line memory 102 includes, for example, a RAM. The line memory 102 stores the pixel data of the input image acquired by the acquisition portion 101.

The line memory 102 need only be capable of storing as many rows of pixel data as the number of taps of the interpolation filter 103.

The interpolation filter 103 generates pixel data for each pixel of the output image from the plurality of rows of pixel data of the input image stored in the line memory 102.

The same filter 103 generates pixel data for each pixel of the output image from the plurality of rows of pixel data of the input image appropriate to the number of taps of the interpolation filter 103.

The same filter 103 generates a plurality of pixel data of the output image successively one row at a time in the direction in which the input image is raster scanned.

Then, the ordinary enlargement/reduction section 100 outputs, in an ‘as-is’ manner, the plurality of pixel data of the output image generated by the interpolation filter 103 one row at a time in the raster scan direction, thus allowing the pixel data to be stored in the external storage section 11.

As a result, the external storage section 11 stores the digital image data made up of the plurality of pixel data of the output image with the number of pixels converted from that of the input image.

It should be noted that the number of rows of the output image generated by the interpolation filter 103 based on the input image is appropriate to the enlarging or reducing ratio of the image.

Further, the number of pixels per row of the output image generated by the interpolation filter 103 based on the input image is appropriate to the enlarging or reducing ratio of the image.

[Problems with Ordinary Enlarging or Reducing Processing]

In order to acquire an output image enlarged or reduced at a desired ratio with the ordinary enlargement/reduction section 100, it is necessary for the line memory 102 to be able to store a whole line of the input image.

Further, it is necessary for the line memory 102 to be capable of storing as many rows as the number of vertical taps of the interpolation filter 103.

With increasing image pixel count in recent years, the input image size has been growing year after year. As a result, the storage capacity necessary for the line memory 102 has a tendency to rise every year.

A possible countermeasure to prevent the storage capacity of the line memory 102 from growing would be to enlarge or reduce the image using the line memory 102 whose storage capacity is smaller than one line of the input image.

In this case, the enlarging or reducing of each pixel is performed sequentially by replenishing next pixel data when a free space is made available in the line memory 102 after the data stored in the same memory 102 is processed.

Although this sequential process can prevent the storage capacity of the line memory 102 from growing, it is necessary to read the same pixel data into the line memory 102 repeatedly a plurality of times so as to process each pixel sequentially.

As a result, the sequential process leads to significantly reduced conversion speed.

More specifically, in order to process pixel data of the nth line, for example, pixel data of the (n+1)th line and so on appropriate to the enlarging or reducing ratio is necessary. Therefore, it is necessary to read pixel data in these other rows.

Further, while the pixel data of the nth line is processed, the pixel data of the (n+1)th line of the line memory 102 is sequentially updated.

When the nth line is processed, the first piece of pixel data of the (n+1)th line has already been deleted from the line memory 102.

In order to process the nth line and then the (n+1)th line without interruption in the sequential process, therefore, it is necessary to read the pixel data of the (n+1)th line again.

The same is true for pixel data of other rows. Hence, the sequential process leads to a larger amount of data accessed and a larger number of data accesses in the external storage section 11.

The amount of data accessed and the number of data accesses increase proportionally to the number of filtering taps.

Further, as the amount of data accessed and the number of data accesses increase, it is necessary for the interpolation filter 103 to wait for necessary data for conversion of a next pixel to be made available for each pixel during the sequential process of a plurality of pixels.

This causes the conversion to stall during this period.

As a result, the sequential process leads to significantly reduced conversion speed.

### [Description of Enlarging or Reducing Processing in Present Embodiment]

In the present embodiment, therefore, an independently developed multi-pass scaling method is used for enlarging or reducing of an image.

The term “multi-pass scaling method” refers to dividing an image to be processed into a plurality of rectangular areas so as to divide each row into a plurality of parts and enlarge or reduce each of the rectangular divided areas.

Thanks to this multi-pass scaling, the present embodiment provides reduced storage capacity of the line memory 22 without reducing the processing speed unlike the sequential process.

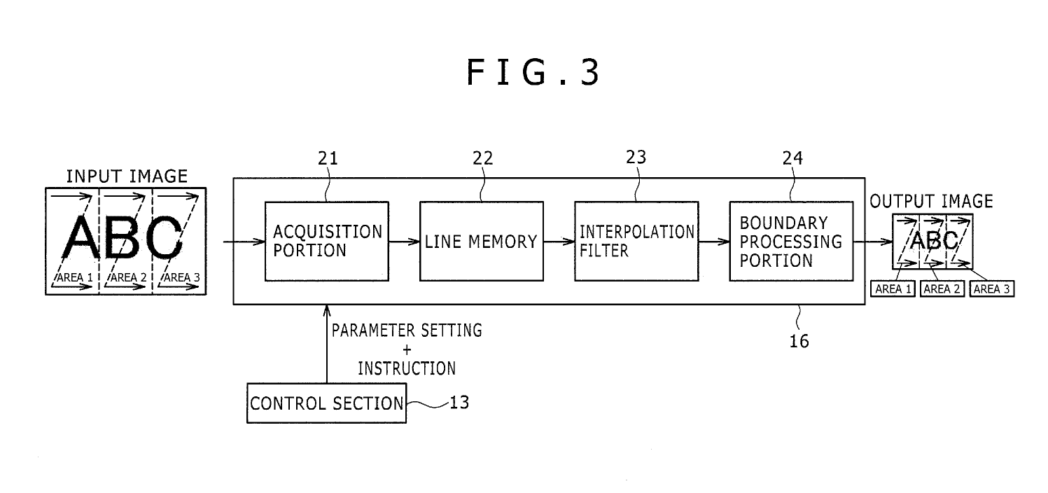

FIG. 3 is a block diagram illustrating the enlargement/reduction section 16 shown in FIG. 1.

The enlargement/reduction section 16 shown in FIG. 3 includes an acquisition portion 21, line memory 22, interpolation filter 23 and boundary processing portion 24.

Further, FIG. 3 illustrates an input image on the left of the enlargement/reduction section 16 and an output image on the right thereof to describe multi-pass scaling.

FIG. 3 illustrates an example in which each of the input and output images is divided into three equal parts.

Multi-pass scaling divides the input and output images in the row direction by the number of divisions appropriate to the storage capacity of the line memory 22, thus enlarging or reducing the partial image in each of the rectangular divided areas.

During enlarging or reducing of each of the rectangular areas, the partial image is processed in the raster scan direction in the same manner as in ordinary enlarging or reducing processing.

In order to achieve multi-pass scaling, the control section 13 sets various parameters in the acquisition portion 21, line memory 22, interpolation filter 23 and boundary processing portion 24 for each divided area.

Further, the control section 13 instructs the enlargement/reduction section 16 to enlarge or reduce the partial image in each divided area.

The acquisition portion 21 shown in FIG. 3 acquires pixel data of the divided area specified by the input image parameters by reading the data from the external storage section 11.

The acquisition portion 21 reads a plurality of pixel data of the partial image in each of the divided areas of the input image one line at a time in the raster scan direction as illustrated by an arrow line in the input image in FIG. 3.

Further, if overlapping areas are provided in the divided areas as described later, the acquisition portion 21 acquires a plurality of pixel data for an area larger than one of the divided areas obtained by dividing the input image by the number of divisions during processing of each of the divided areas.

The line memory 22 includes, for example, a RAM. The line memory 22 temporarily stores pixel data of a divided area of the input image acquired by the acquisition portion 21.

The line memory 22 can hold as many lines of data as necessary for vertical interpolation performed by the interpolation filter 23.

The line memory 22 stores a plurality of rows of pixel data appropriate to the number of taps of vertical interpolation.

The interpolation filter 23 generates pixel data for each pixel in each divided area of the output image using a plurality of rows of pixel data of the associated divided area of the input image stored in the line memory 22.

The interpolation filter 23 generates pixel data of the output image from rows of a plurality of pixel data appropriate to the number of filter taps. For example, the same filter 23 generates each piece of pixel data of the output image from three rows by three columns of pixel data of the input image.

The interpolation filter 23 generates each piece of pixel data of the output image, for example, through weighted summation of a plurality of pixel data of the input image. The same filter 23 does so, for example, by multiplying each piece of pixel data of the input image by a weighting factor appropriate to the distance to the output image to be generated and summing up a plurality of products.

The interpolation filter 23 generates a plurality of pixel data for the divided areas of the output image successively one row at a time in the raster scan direction.

On the other hand, if overlapping areas are provided in the divided areas as described later, the interpolation filter 23 generates a plurality of pixel data for an area larger than one of the divided areas obtained by dividing the output image by the number of divisions during processing of each of the divided areas.

The boundary processing portion 24 outputs the plurality of pixel data for the divided areas of the output image generated by the interpolation filter 23 externally from the enlargement/reduction section 16.

This allows for the plurality of pixel-data for the divided areas of the output image to be stored in the external storage section 11.

On the other hand, if overlapping areas are provided in the divided areas as described later, the boundary processing portion 24 masks the data supplied from the interpolation filter 23.

As a result, the boundary processing portion 24 outputs, during processing of each of the divided areas, only the plurality of pixel data in that divided area of the output image, and does not output unnecessary pixel data in the overlapping areas other than the divided area in question.

It should be noted that if the amount of data per line of the input image is equal to or less than the storage capacity of the line memory 22, the enlargement/reduction section 16 shown in FIG. 3 can read the input image one line at a time for processing as does the ordinary enlargement/reduction section 100.

In this case, it is only necessary for the control section 13 to set parameters in the enlargement/reduction section 16 assuming that the entire input image is a single divided area.

### [Overall Operation for Enlarging or Reducing in Present Embodiment]

When multi-pass scaling is performed, image enlarging or reducing processing as a whole is conducted in the following manner.

First, the control section 13 determines the number of divisions of the input image stored in the external storage section 11.

Next, the control section 13 calculates the parameters of each of the divided areas for multi-pass scaling.

In this calculation of the parameters, the control section 13 calculates, for example, the position and size of each of the divided areas of the input and output images, the sizes of the overlapping areas, and the positions of the pixels in each of the divided areas of the input image relative to the positions of the pixels in each of the divided areas of the output image (relative offsets).

When an image is divided for processing, the arrangement of a plurality of pixels defined in an input image and that of a plurality of pixels defined in an output image are in a relationship appropriate to the enlarging or reducing ratio of the image as a whole.

There is in principle a deviation in the image between the position of each of the pixels defined in the input image and that of the associated pixel defined in the output image.

For example, there is a relative deviation between the position of the first pixel in the second area located second from left of the input image and that of the first pixel in the second area located second from left of the output image when the image is used as a reference.

Therefore, when the image is divided in the row direction and processed on a divided area-by-divided area basis, a relative offset is necessary for each of the divided areas to reduce the deviation between the images at the boundaries between the divided areas, the deviation being generated when combining a plurality of divided areas into a single image.

For example, the enlargement/reduction section 16 uses this offset to calculate the relative distance from each piece of pixel data of the input image to the associated piece of pixel data of the output image, thus calculating the pixel data of the output image.

Further, the same section 16 multiplies each piece of the pixel data of the input image by a weighting factor appropriate to the relative distance and sums up a plurality of products resulting from the multiplication, thus generating each piece of pixel data of the output image. It should be noted that the enlargement/reduction section 16 may. select a weighting factor appropriate to the relative distance, for example, from the data in the table associating a plurality of relative distance ranges and a plurality of factors.

When the calculation of all the parameters is complete, the control section 13 initiates the enlarging or reducing processing.

The control section 13 sets the parameters for the first divided area in the enlargement/reduction section 16 and instructs the same section 16 to proceed with the enlarging or reducing processing.

As a result, the enlargement/reduction section 16 reads the first divided area of the input image from the external storage section 11, generating an output image with a changed pixel count in the divided area and storing the pixel data of the output image in the external storage section 11.

The same section 16 notifies the control section 13 of the completion of the enlarging or reducing processing.

When notified of the completion of the enlarging or reducing processing in the first divided area, the control section 13 sets the parameters in the next divided area and instructs the enlargement/reduction section 16 to proceed with the enlarging or reducing processing again.

The control section 13 repeats the above control until the enlarging or reducing processing of all the divided areas of the target image is complete.

When the enlarging or reducing processing of all the divided areas is complete, a plurality of image data for the plurality of divided areas are stored in the external storage section 11. These pieces of image data are written to the external storage section 11 on a divided area-by-divided area basis.

The partial images of the plurality of divided areas are combined into a single image in the external storage section 11 for use as digital image data of the output image.

After generating an output image, the control section 13 instructs the interface section 17 to output the output image.

The same section 17 reads the digital image data of the output image from the external storage section 11, outputting the digital image data externally from the image converter 1.

For example, the interface section 17 reads the plurality of pixel data of the output image successively in the raster scan direction, thus outputting the data externally.

Thanks to the multi-pass scaling as described above, the present embodiment enlarges or reduces the image on a divided area-by-divided area basis on a plurality of separate occasions.

In the present embodiment, therefore, there is no need for the line memory 22 to store all the pixel data in each line of the input image.

This keeps the growth in storage capacity of the line memory 22 to a minimum or even provides reduced storage capacity thereof.

In the present embodiment, on the other hand, the pixel data of the (n+1)th line, acquired at the time of enlarging or reducing the pixel data of the nth line, remains stored in the line memory 22 when the enlarging or reducing of the nth line is complete.

This eliminates the need for the image converter to read the pixel data of the (n+1)th line again when enlarging or reducing the nth line and then the (n+1)th line without interruption.

As described above, unlike the sequential process, there is no need to read the same pixel data a plurality of times in the present embodiment.

This prevents the amount of data accessed in the external storage section 11 from growing, which is not the case in the sequential process.

The present embodiment remains free from significant reduction in processing speed encountered in the sequential process.

[Specific Description of Case in which Overlapping Areas are Provided]

Incidentally, if an image is divided into a plurality of areas for separate enlarging or reducing, and then the partial images of the divided areas are combined into a single image in the external storage section 11 as illustrated in FIG. 3, an originally one image is divided into a plurality of partial images, and these partial images are separately processed.

Therefore, it is likely that the image may be discontinuous at the boundaries of division of the output image.

The combined image may be visually perceived as disconnected at the boundaries.

To prevent or keep discontinuity in the image at the boundaries to a minimum, the present embodiment performs overlapping and clipping (masking).

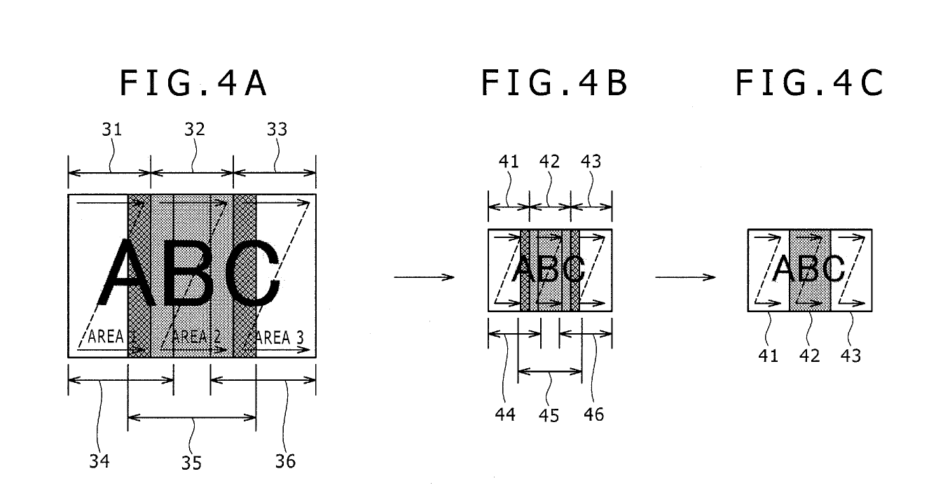

FIGS. 4A to 4C are explanatory diagrams illustrating an example of a plurality of divided areas when overlapping areas are provided in each of the divided areas.

FIG. 4A illustrates an input image to be overlapped.

FIG. 4B illustrates an intermediate image, output from the interpolation filter 23, to be clipped.

FIG. 4C illustrates a clipped output image to be stored in the external storage section 11.

On the other hand, FIGS. 4A to 4C illustrate an example in which the image is divided into three equal parts, namely, first area (area 1), second area (area 2) and third area (area 3).

It should be noted that the plurality of divided areas do not necessarily have the same width.

For example, if an image is divided into a plurality of areas, each having the number of pixels that can be stored in the line memory 22, the last rightmost divided area is normally less wide than the other divided areas.

For example, if the width of the image as a whole is an integer multiple of the number of pixels that can be stored in the line memory 22, the width of the image including that of the rightmost divided area is divided into equal parts.

The input image is divided into three equal parts, i.e., first, second and third equally divided areas 31, 32 and 33, as illustrated in FIG. 4A.

If overlapping is performed, the acquisition portion 21 acquires an area wider than the first equally divided area 31 as a first area 34 during processing of the first divided area as illustrated at the bottom in FIG. 4A.

That is, the acquisition portion 21 acquires, in addition to the first equally divided area 31 and as an overlapping area, the left-edge portion of the second equally divided area 32 located adjacent to and on the right of the first equally divided area 31.

Similarly, the acquisition portion 21 acquires an area wider than the second equally divided area 32 as a second area 35 during processing of the second divided area.

That is, the acquisition portion 21 acquires, in addition to the second equally divided area 32 and as overlapping areas, the right-edge portion of the first equally divided area 31 located adjacent to and on the left of the second equally divided area 32 and the left-edge portion of the third equally divided area 33 located adjacent to and on the right of the second equally divided area 32.

Further, the acquisition portion 21 acquires an area wider than the third equally divided area 33 as a third area 36 during processing of the third divided area.

That is, the acquisition portion 21 acquires, in addition to the third equally divided area 33 and as an overlapping area, the right-edge portion of the second equally divided area 32 located adjacent to and on the left of the third equally divided area 33.

When an overlapping area or areas are acquired during processing of each of the divided areas, the interpolation filter 23 processes the pixels including those in the overlapping areas stored in the line memory 22 in the order in which they are read.

As a result, the interpolation filter 23 outputs pixel data of divided areas of an output image covering the areas wider than equally divided areas 41 to 43 of the output image during processing of each of the divided areas.

More specifically, the interpolation filter 23 generates a partial image 44 wider to the right than the first equally divided area 41 as illustrated in FIG. 4B during processing of the first divided area as a partial image of the first divided area of the output image.

The interpolation filter 23 generates the partial image 44 including the first equally divided area 41 and the left-edge portion of the second equally divided area 42 located adjacent to and on the right of the first equally divided area 41.

Similarly, the interpolation filter 23 generates a partial image 45 wider to the left and right than the second equally divided area 42 during processing of the second divided area.

The interpolation filter 23 generates the partial image 45 including the second equally divided area 42, the right-edge portion of the first equally divided area 41 located adjacent to and on the left of the second equally divided area 42, and the left-edge portion of the third equally divided area 43 located adjacent to and on the right of the second equally divided area 42.

Similarly, the interpolation filter 23 generates a partial image 46 wider to the left than the equally divided area 43 during processing of the third divided area.

The interpolation filter 23 generates the partial image 46 including the third equally divided area 43 and the right-edge portion of the second equally divided area 42 located adjacent to and on the left of the third equally divided area 43.

Further, if overlapping areas are included, the boundary processing portion 24 performs clipping (masking).

The boundary processing portion 24 outputs, of the partial image 44, 45 or 46 generated by the interpolation filter 23, the pixel data of only the predetermined divided area 41, 42 or 43 to be processed during processing of each of the divided areas.

In the example shown in FIGS. 4A to 4C, the boundary processing portion 24 outputs the pixel data of only the divided area 41, 42 or 43 of the output image.

That is, the same portion 24 performs masking adapted to output, of the partial image 44, the pixel data of only the first equally divided area 41 of the output image during processing of the first divided area.

The same portion 24 outputs, of the partial image 45, the pixel data of only the second equally divided area 42 of the output image during processing of the second divided area.

The same portion 24 outputs, of the partial image 46, the pixel data of only the third equally divided area 43 of the output image during processing of the third divided area.

As a result, the pixel data of the first equally divided area 41 resulting from the enlarging or reducing processing of the first divided area is written first to the external storage section 11 as illustrated in FIG. 4C.

The pixel data of the second equally divided area 42 resulting from the enlarging or reducing processing of the second divided area is written next to the external storage section 11.

The pixel data of the third equally divided area 43 resulting from the enlarging or reducing processing of the third divided area is written last to the external storage section 11.

As described above, the data of the plurality of divided areas is written in the order in which the divided areas are processed.

Further, the partial images of all the divided areas are assembled into a complete output image in the external storage section 11.

As described above, in the present embodiment, overlapping area or areas are defined for each of the divided areas for overlapping and masking by the enlargement/reduction section 16.

As a result, the pixel data of the boundary columns of each of the divided areas of the output image reflects the pixel data of other adjacent divided areas of the input image.

Separately generated two columns of pixel data, one on each side of the boundary, include values that refer to each other.

It is possible to prevent the image from being visually perceived as disconnected at the boundaries.

Further, in the present embodiment, the boundaries are processed through a combination of overlapping and masking.

In the present embodiment, therefore, it is not necessary for the enlargement/reduction section 16 to have any additional memory other than the line memory 22.

For example, if a value is corrected using data of other divided area during processing of each of the divided areas, it is necessary to provide a memory between the interpolation filter 23 and boundary processing portion 24. This memory is used to hold the data of the divided area processed earlier until enlarging or reducing of other divided areas.

The present embodiment eliminates the need for such a memory.

In the present embodiment, on the other hand, the boundary processing portion 24 performs masking so that unnecessary data of the overlapping areas is not output during processing of each of the divided areas.

This makes it possible for the boundary processing portion 24 to control data output on a pixel-by-pixel basis simply by counting, on a row-by-row basis, the plurality of pixel data output in a given order from the interpolation filter 23.

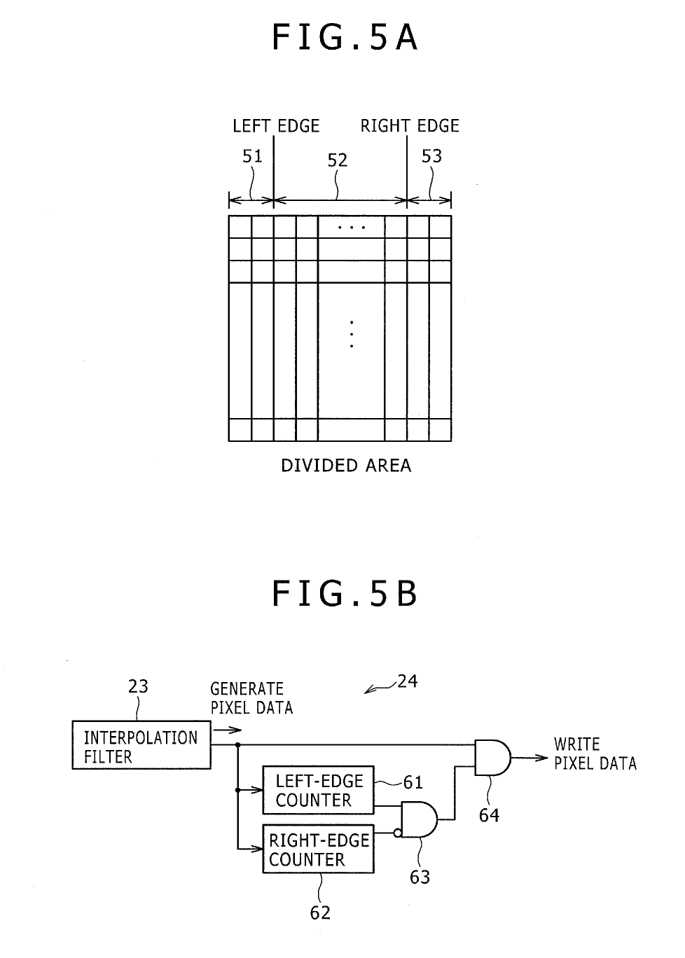

FIGS. 5A and 5B are explanatory diagrams of masking.

FIG. 5A is an explanatory diagram of a divided area including overlapping areas output from the interpolation filter 23 to the boundary processing portion 24.

The divided area shown in FIG. 5A has a left overlapping area 51 on the left of a central area 52 whose pixel data is to be output and a right overlapping area 53 on the right thereof.

In the divided area shown in FIG. 5A, it is necessary to output the pixel data of the central area 52 located between the left and right overlapping areas 51 and 53.

FIG. 5B is a block diagram of the components of the boundary processing portion 24 shown in FIG. 3 adapted to handle masking.

The boundary processing portion 24 shown in FIG. 5B includes a left-edge counter 61, right-edge counter 62, first AND circuit 63 and second AND circuit 64.

The boundary processing portion 24 shown in FIG. 5B is supplied with the pixel data of the divided area shown in FIG. 5A from the interpolation filter 23 one row at a time in the direction of raster scanning the partial image.

If the pixels are processed in the raster scan direction, the plurality of pixels in each row are processed from left to right in FIG. 5A.

The left-edge counter 61 counts, for example, the number of pixels in the left overlapping area 51 shown in FIG. 5A.

The same counter 61 is reset row by row and outputs ‘0’ (low level) when reset.

The same counter 61 starts counting when the supply of a row of pixel data begins.

The left-edge counter 61 outputs ‘1’ (high level) when it finishes counting the number of pixels in the left overlapping area 51.

Then, the left-edge counter 61 continues to output ‘1’ until it is reset.

The right-edge counter 62 counts, for example, the number of pixels in the left overlapping area 51 and central area 52 shown in FIG. 5A.

The same counter 62 is reset row by row and outputs ‘0’ when reset.

The right-edge counter 62 starts counting when the supply of a row of pixel data begins.

The right-edge counter 62 outputs ‘1’ when it finishes counting the number of pixels in the left overlapping area 51 and central area 52.

Then, the right-edge counter 62 continues to output ‘1’ until it is reset.

The first AND circuit 63 is connected to the left-edge counter 61 and right-edge counter 62.

The input from the right-edge counter 62 is inverted.

Then, the first AND circuit 63 outputs ‘1’ while the left-edge counter 61 outputs ‘1’ and the right-edge counter 62 outputs ‘0.’

That is, the first AND circuit 63 outputs ‘0’ for the pixels in the left overlapping area 51, ‘1’ for the pixels in the central area 52 and ‘0’ for the pixels in the right overlapping area 53.

The second AND circuit 64 is connected to the interpolation filter 23 and first AND circuit 63.

When the output of the first AND circuit 63 is high (1), the second AND circuit 64 outputs the pixel data, supplied from the interpolation filter 23, in an ‘as-is’ manner.

When the output of the first AND circuit 63 is low (0), the second AND circuit 64 masks the pixel data, supplied from the interpolation filter 23, so that this data is not output.

That is, the second AND circuit 64 outputs, of the pixel data supplied from the interpolation filter 23, only the data of the central area 52 for which the first AND circuit 63 outputs a high level.

This allows for the second AND circuit 64 to control the plurality of pixel data output from the interpolation filter 23 on a pixel-by-pixel basis, thus achieving masking in such a manner that the pixel data of only the central area 52 is output.

### [Specific Example of Operation of Image Converter 1]

A specific description will be given below of multi-pass scaling performed by the image converter 1 shown in FIG. 1.

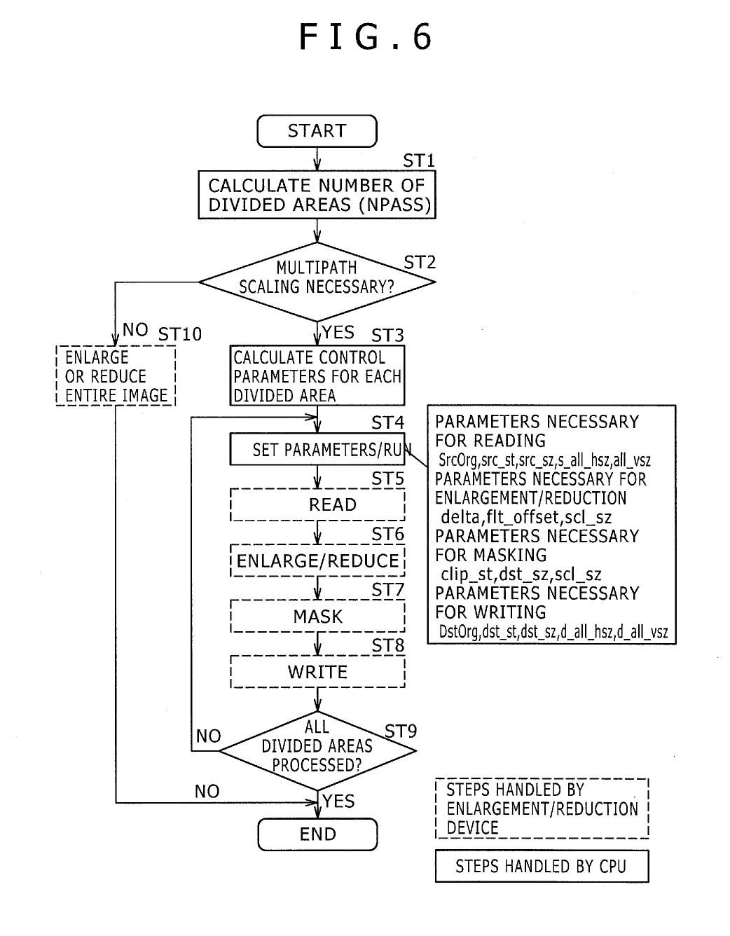

FIG. 6 illustrates an example of processing sequence of the image converter 1 for performing multi-pass scaling.

The image converter 1 performs multi-pass scaling shown in FIG. 6 when a given input image is stored in the external storage section 11.

Calculating the number of divisions (step ST1)

When an input image is written to the external storage section 11, the control section 13 initiates the enlarging or reducing processing.

The control section 13 determines whether multi-pass scaling is necessary and then calculates the number of divisions first to calculate various parameters.

The input and output images are divided by the same number of divisions.

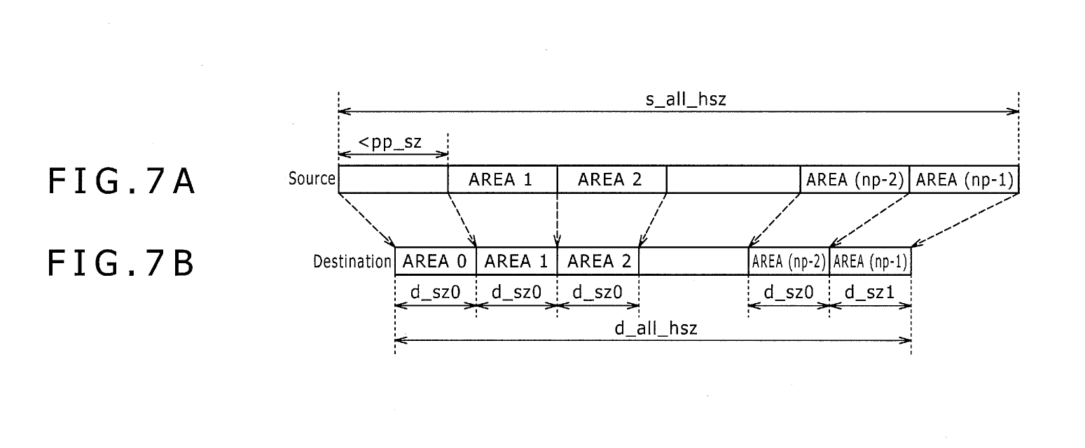

FIGS. 7A and 7B are diagrams describing the relationship between a line of the input image and a line of the output image.

FIG. 7A illustrates a line of the input image.

FIG. 7B illustrates a line of the output image.

In FIGS. 7A and 7B, one line of each of the input and output images is equally divided into areas 0 to (np-1) or np parts (where np is a natural number).

Letting the number of divided areas subject to multi-pass scaling be denoted by ‘npass,’ the control section 13 finds the number of divisions by the formula shown below using the parameters related to the divided areas shown in FIGS. 7A and 7B.

(INT)npass=(s_all_{—}hsz−1)/pp_{—}sz+1 Formula 1

Here, s_all_hsz is the number of horizontal pixels of the input image as illustrated in FIGS. 7A and 7B.

pp_sz is the maximum number of horizontal pixels in each divided area.

It should be noted that pp_sz is the maximum number of pixels that can be stored in the line memory 22 per line of the image.

It should be noted, however, that if overlapping areas are provided, pp_sz is the number obtained by subtracting the number of pixels in the overlapping areas from the maximum number of pixels.

For example, if s_all_hsz is 100, if the maximum number of pixels that can be stored in the line memory 22 is 50, and if pp_sz is 40, Formula 1 gives (100−1)/40+1=(INT)3.475=3

In this case, the number of divisions of the image is 3.

Determining whether multi-pass scaling is necessary (step ST2)

Next, the control section determines whether multi-pass scaling is necessary.

If the number of divisions is 1, it is only necessary to deal with data equal to or smaller in size than the data that can be stored in the line memory 22 in enlarging or reducing each row. Therefore, multi-pass scaling is not necessary.

In this case, the control section 13 need only enlarge or reduce each row in the same manner as for ordinary enlarging or reducing processing.

The control section 13 sets the parameters established in advance for the entire image in the enlargement/reduction section 16 without calculating the parameters shown below that are necessary for multi-pass scaling, thus proceeding with enlarging or reducing processing once (step ST10).

In this case, the boundary processing section 24 outputs the data from the interpolation filter 23 externally in an ‘as-is’ manner.

It should be noted that the control section 13 may read the input image or information related thereto from the external storage section 11 to determine whether the enlarging or reducing processing is necessary.

For example, the control section 13 determines whether the number of horizontal pixels of the input image is equal to or less than the number of pixels per line that can be stored in the line memory 22.

It should be noted that the control section 13 may compare the total amount of horizontal pixel data of the input image against the storage capacity of the line memory 22 per row.

Then, if the number of horizontal pixels of the input image is equal to or less than the number of pixels that can be stored in the line memory 22, the control section 13 determines that multi-pass scaling is unnecessary, thus exercising control for ordinary enlarging or reducing processing.

When the number of horizontal pixels of the input image is greater than the number of pixels that can be stored in the line memory 22, the control section 13 exercises control for multi-pass scaling.

Calculating the parameters for multi-pass scaling (step ST3)

Next, the control section 13 calculates various parameters to be set in the enlargement/reduction section 16.

In the description given below, “(INT)” in the calculation formulas refers to the integer part of the value obtained by the real number calculation on the right side.

On the other hand, “(FRACT)” in the calculation formulas refers to the fractional part of the value obtained by the real number calculation on the right side. The number of digits in this fractional part translates into the hardware bit accuracy for real number calculation (internal calculation bit accuracy of the enlargement/reduction section 16.)

A real number is produced if it does not include “(INT)” or “(FRACT).”

Calculating the horizontal size of each partial image of the output image

After calculating the number of divisions, the control section 13 calculates temporary horizontal sizes d_sz0 and d_sz1 of the divided areas of the output image (Destination).

The horizontal sizes of the partial images in the divided areas of the output image are calculated by the formulas shown below.

(INT)d_{—}sz0=d_all_{—}hsz/npass Formula 2

(INT)d_{—}sz1=d_all_{—}hsz−d_{—}sz0×(npass−1) Formula 3

Here, d_sz0 is the horizontal size of each of the partial images in the zeroth to (npass−2)th areas when the output image is divided into n parts (where n is a natural number).

d_sz1 is the horizontal size of the partial image in the (npass−1)th area.

These parameters are used to calculate the parameters related to the boundary pixels in each of the divided areas which will be described later.

In the description given below, area numbers 0 to n−1 will be used.

On the other hand, d_all_hsz is the number of pixels of the output image.

For example, when npass is 3 and d_all_hsz is 33, d_sz0 is 11 (=33/3) and d_sz1 is 11 (=33−11×(3−1)).

Calculating the parameters related to the boundary pixel strings in the divided areas of the input and output images

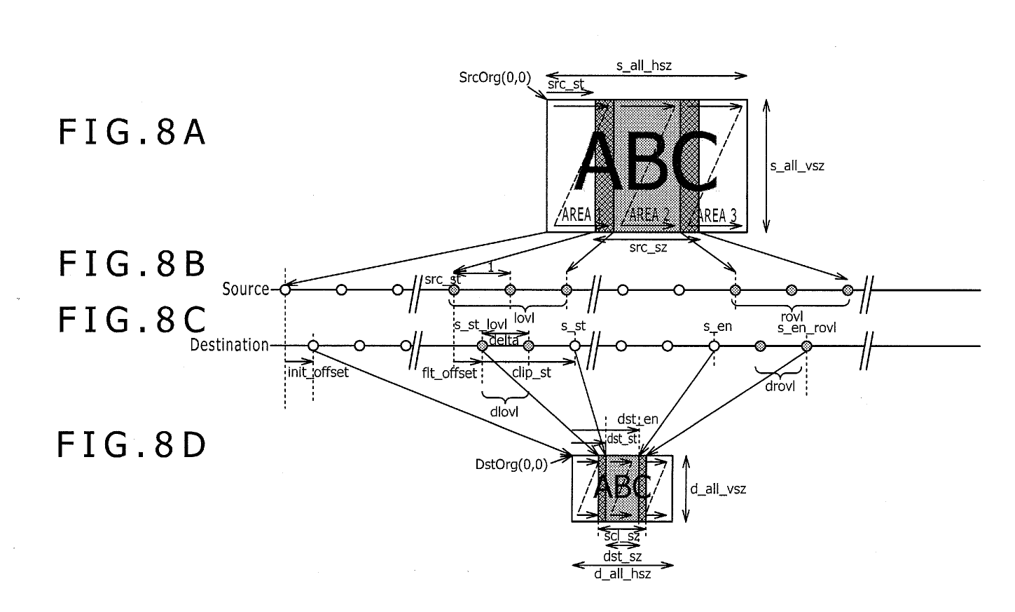

FIGS. 8A to 8D are conceptual diagrams illustrating the relationship between the divided areas of the input image and those of the output image.

FIG. 8A illustrates an input image.

FIG. 8B illustrates a line of the input image.

FIG. 8C illustrates a line of the output image.

FIG. 8D illustrates an output image.

Here, the control section 13 finds parameters for the boundary pixel strings in the divided areas of the output image, namely, s_st, s_en, dst_st and dst_en.

s_st represents the relative position (phase) of the leftmost pixel string of the partial image of the output image in the input image.

s_en represents the relative position (phase) of the rightmost pixel string of the partial image of the output image in the input image.

Here, the positions of the pixel strings in the input image are found when the relative distance between the pixels, defined in a matrix form in the input image, is 1.

Each of the values is a real number. The accuracy of the values varies normally depending on the hardware calculation accuracy (internal calculation accuracy of the enlargement/reduction section 16).

Further, the control section 13 calculates the delta value, i.e., the enlarging or reducing ratio calculated from s_all_hsz and d_all_hsz.

dst_st and dst_en represent the positions of the boundary pixel strings in the output image that are necessary for writing the partial images of the output image to the external storage section 11.

Designed to represent the pixel positions in the output image, these values are integers in a two-dimensional coordinate system.

It should be noted that the values s_st, s_en, dst_st and dst_en calculated here do not include the overlapping areas shaded in FIGS. 8A to 8D.

The overlapping areas are corrected by the additional process which will be described later.

The delta value representing the enlarging or reducing ratio between the input and output image is calculated by the formula shown below.

The delta value is a real number in the range with a bit accuracy that varies depending on the hardware configuration.

delta=s_all_{—}hsz/d_all_{—}hsz Formula 4

Letting the variable representing the divided area number be denoted by ‘pass,’ s_st and s_en of each of the divided areas of the input image can be calculated by the formulas shown below.

s_st[0]=init_offset Formula 5

s_{—}st[pass]=s_{—}st[pass−1]+d_{—}sz0×delta (1≦pass<npass) Formula 6

s_{—}en[pass]=s_{—}st[pass+1]−delta (0≦pass<npass−1) Formula 7

s_{—}en[npass−1]=s_{—}st[0]+s_all_{—}hsz−1 Formula 8

Here, the initial phase of the start pixel of the first divided area (area with pass=0) of the output image is defined to be init_offset (real number).

s_st and s_en of each of the divided areas are calculated by using this initial phase of the relative offset as a starting point.

On the other hand, dst_st and dst_en are calculated by the formulas shown below.

(INT)dst_{—}st[0]=0 Formula 9

(INT)dst_{—}st[pass]=dst_{—}st[pass−1]+d_{—}sz0 (1≦pass<npass) Formula 10

(INT)dst_{—}en[pass]=dst_{—}st[pass+1]−1 (0≦pass<npass−1) Formula 11

(INT)dst_{—}en[npass−1]=dst_{—}st[0]+d_all_{—}hsz−1 Formula 12

The control section 13 repeats the above calculations as many times as the number of divided areas.

As a result, the parameters related to the boundary pixels for all the divided areas excluding the overlapping areas are calculated.

Additional process performed on the overlapping areas

Next, the control section 13 further adds overlapping area conditions to the parameters related to the boundary pixel strings for each of the divided areas found by Formulas 5 to 12 without including the overlapping areas.

This allows for the control section 13 to calculate the parameters for each of the divided areas including the overlapping areas.

The parameters calculated here are flt_offset, src_st, clip_st, s_st_lovl, s_en_rovl, dlovl, drovl, src_sz, scl_sz and dst_sz shown in FIGS. 8A to 8D.

Further, the number of pixels in the left overlapping area 51 of the appropriate divided area of the input image is defined to be lovl, and the number of pixels in the right overlapping area 53 rovl.

Although the numbers of pixels in the overlapping areas of the input image may be arbitrary values, these numbers are fixed values restricted by the storage capacity of the line memory 22.

The above-mentioned maximum number of pixels pp_sz in each divided area is equal to or smaller than the value obtained by subtracting lovl and rovl from the maximum number of pixels that can be stored in the line memory 22 per line.

The control section 13 calculates the parameters related to the left overlapping area 51 by the formulas shown below.

(INT)dlovl[pass]=(lovl−1+(FRACT)s_{—}st[pass]−1)/delta+1 Formula 13

s_{—}st_lovl[pass]=s_{—}st[pass]−dlovl×delta Formula 14

Here, s_st_lovl is the value obtained by including the left overlapping area 51 and correcting s_st with the overlapping area.

dlovl is the number of overlapping pixels of the output image.

On the other hand, there is no need to provide a left overlapping area in the leftmost divided area (pass=0).

Therefore, when pass=0, the following values are used.

(INT)dlovl[0]=0 Formula 15

s_{—}st_lovl[0]=s_{—}st[0] Formula 16

Next, the control section 13 calculates the values of src_st, flt offset and clip st by the formulas shown below using the values obtained by Formulas 13 to 16.

src_st represents the left-edge pixels in the divided area of the input image including the overlapping areas.

flt_offset represents the phase difference between the left-edge pixel in the divided area of the output image and the src_st pixel string in the input image.

clip_st represents the number of pixels in the left overlapping area 51 masked by the boundary processing portion 24.

(INT)clip_{—}st[pass]=dlovl Formula 17

(INT)src_{—}st[pass]=s_{—}st_lovl Formula 18

flt_offset[pass]=(FRACT)s_{—}st Formula 19

Here, flt_offset is found by the real number s_st obtained from Formulas 5 and 6 as illustrated in Formula 19.

This value represents the distance (real number) from an origin SrcOrg(0,0) of the input pixel (Source pixel) shown in FIGS. 8A to 8D to the first output pixel (Destination pixel) of the divided area (second area in FIGS. 8A to 8D) to be processed.

This value is converted into the distance from src_st, i.e., the first input pixel (Source pixel) in the second area, which is flt_offset illustrated in Formula 19.

This prevents image misalignment between divided areas even if the image is divided into a plurality of divided areas for enlarging or reducing.

As a result, it is less likely that an image may be discontinuous at the boundaries between the divided areas. That is, it is possible to obtain an image with the same quality as that obtained by enlarging or reducing in one operation.

Further, the control section 13 calculates the parameters related to the right overlapping area 53.

drovl[pass]=(rovl−1+(1−(FRACT)s_{—}en[pass])−1)/delta+1 Formula 20

s_{—}en_rovl[pass]=s_{—}en[pass]+drovl×delta Formula 21

Here, s_en_rovl is the value of the right-edge pixel string obtained by correcting the divided area of the output image with the right overlapping area 53.

drovl is the number of pixels in the right overlapping area 53 of the divided area of the output image.

It should be noted, however, that the right overlapping area 53 is not provided in the rightmost divided area (pass=npass−1). Therefore, the following values are used.

(INT)drovl[pass−1]=0 Formula 22

s_{—}en_rovl[pass−1]=s_{—}en[pass] Formula 23

Next, the control section 13 calculates src_sz, i.e., the size of the divided area of the input image including the overlapping areas, and scl_sz, i.e., the size of the divided area of the output image including the overlapping areas.

It should be noted that the enlargement/reduction section 16 reads src_sz worth of pixel data of the input image, generates scl_sz worth of pixel data of the output image through filtering and outputs the pixel data excluding that of the overlapping areas through masking during processing of each of the divided areas.

The boundary processing portion 24 masks the overlapping areas of the scl_sz worth of pixel data generated by the interpolation filter 23 using the clip_st and dst_sz parameters, thus outputting only the dst_sz worth of pixel data to the external storage section 11.

dst_sz is the size of the area output during division.

These parameters can be found by the formulas shown below.

(INT)src_{—}sz[pass]=(INT)s_{—}en_rovl[pass]−(INT)s_{—}st_lovl[pass]+2 Formula 24

(INT)scl_{—}sz[pass]=dst_{—}en[pass]−dst_{—}st[pass]+dlovl+drovl+1 Formula 25

(INT)dst_{—}sz[pass]=dst_{—}en[pass]−dst_st[pass]+1 Formula 26

Setting the parameters and instructing the enlargement/reduction section 16 to proceed with the enlarging or reducing processing (step ST4)

The control section 13 finds the parameters necessary for the enlarging or reducing processing as described above.

The same section 13 sets the parameters found earlier in the enlargement/reduction section 16 via the control bus 15, thus instructing that the partial image in the divided area be processed.

The control section 13 sets the parameters calculated for each of the divided areas in the enlargement/reduction section 16, causing the same section 16 to repeatedly proceed with the enlarging or reducing processing on a divided area-by-divided area basis.

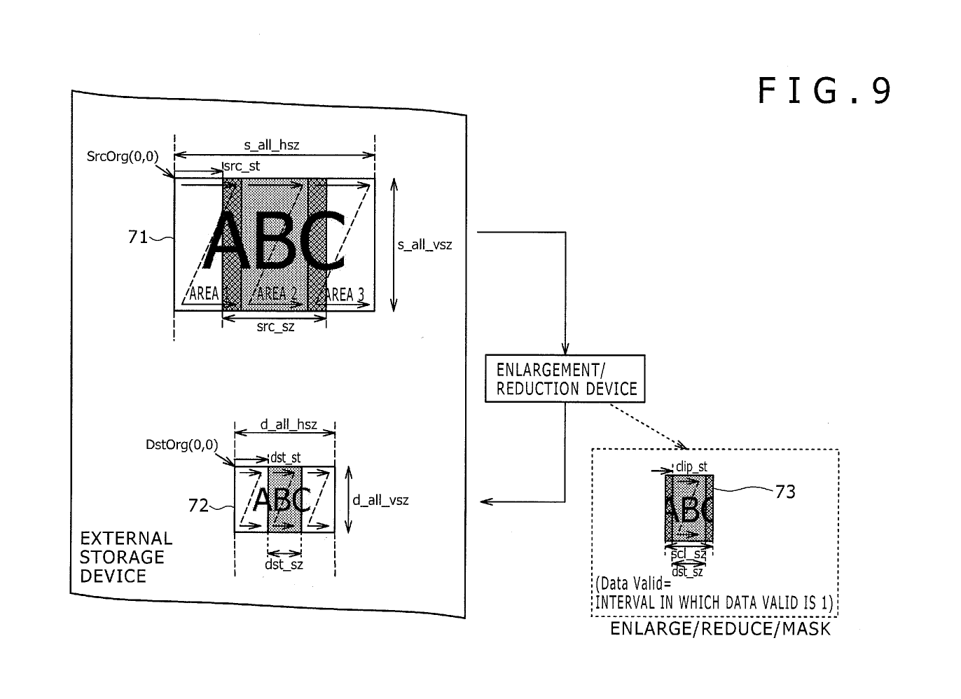

At this time, the parameters actually set in the enlargement/reduction section 16 are shown in FIG. 9.

FIG. 9 is an explanatory diagram of various parameters calculated by the control section 13.

The parameters for the input and output images 71 and 72 stored in the external storage device are shown on the left in FIG. 9.

The parameters for a partial image 73 in the divided area are shown on the right in FIG. 9.

More specifically, the control section 13 sets the parameters necessary to read the input image in the acquisition portion 21.

More specifically, the control section 13 sets SrcOrg(0,0), i.e., the origin of the Source pixel in the divided area of the input image, src_st, src_sz, s_all_hsz and s_all_vsz. s_all_vsz is the number of vertical pixels of the input image.

Further, the control section 13 sets delta, flt_offset and scl_sz in the interpolation filter 23 adapted to perform enlarging or reducing.

Still further, the control section 13 sets clip_st, dst_sz and scl_sz in the boundary processing portion 24 adapted to perform masking.

Still further, the control section 13 sets DstOrg(0,0), dstst, dst_sz, dallhsz and d all vsz in the boundary processing portion 24 to write the output image (Destination). d_all_vsz is the number of vertical pixels of the output image.

The enlargement/reduction section 16 performs each of the process steps shown in the sequence diagram of FIG. 6 using these parameters.

Reading (step ST5)

The acquisition portion 21 reads the input image when instructed by the control section 13.

During this image reading, the acquisition portion 21 reads, from the external storage section 11 into the line memory 22, src_sz pixels worth of data starting from the first pixel src_st in a given divided area with the origin set at SrcOrg(0,0).

The acquisition portion 21 reads the pixel data in each row of the partial image sequentially in the raster scan direction during reading of the data in each of the divided areas.

When the reading of s_all_vsz lines of pixel data is complete, the acquisition portion 21 terminates the reading of the pixel data of the partial image in each divided area.

Enlarging or reducing processing (step ST6)

When a given number of lines of pixel data are read into the line memory 22, the interpolation filter 23 proceeds with the enlarging or reducing processing based on the set parameters. The given number is equal to the number of taps.

The interpolation filter 23 generates scl_sz pixels of pixel data using the initial phase flt_offset and the delta value.

As a result, the interpolation filter 23 generates one line of pixel data in the partial image of the output image.

The interpolation filter 23 generates pixel data of the output image row by row of the partial image in the order in which the pixel data is read by the acquisition portion 21, i.e., in the raster scan direction.

At this time, the pixel data is sequentially read into the line memory 22 in the order in which the partial image is raster scanned. Further, when the enlarging or reducing processing of a next row begins, the rows of data that were read in the past remain stored in the line memory 22.

This eliminates the need for the interpolation filter 23 to wait for necessary pixel data to be made available unlike the sequential process.

Further, the interpolation filter 23 repeats the generation of pixel data for each row every d_all_vsz rows of the output image.

This allows for a plurality of pixel data to be generated for the partial image of the output image.

The interpolation filter 23 successively outputs the plurality of pixel data of the partial image of the output image in the order in which the partial image is raster scanned.

Masking (step ST7)

The partial image of the divided area of the output image generated by the enlargement/reduction section 16 includes the overlapping areas.

Therefore, the boundary processing portion 24 performs masking adapted to count the number of pixels row by row of the partial image using clip_st, scl_sz and dst_sz and output only the pixel data falling within the range satisfying the condition of Formula 27.

The same portion 24 associates the Data Valid signal with each piece of the pixel data to be output. The Data Valid signal is ‘1’ when the pixel data satisfies the condition given below. If not, the Data Valid signal is ‘0.’

clip_{—}st≦DstPixelCount<clip_{—}st+dst_{—}sz Formula 27

Further, when the processing proceeds to the next line after the processed line has been updated, the DstPixelCount value is reset to ‘0.’

It should be noted that the Data Valid signal corresponds to the output signal of the first AND circuit 63 in FIG. 5B.

Writing (step ST8)

Further, the boundary processing portion 24 writes, to the external storage section 11, the pixel data to which the Data Valid signal has been added.

This writing of pixel data is sequentially conducted in the raster scan direction relative to the coordinates of the output image shown in FIG. 9.

At this time, the boundary processing portion 24 writes d_all_vsz lines of pixel data with the origin set at DstOrg(0,0).

More specifically, the same portion 24 references the Data Valid signal that has been added in advance to the pixel data during writing.

Then, the boundary processing portion 24 writes, to the dst_st position, the pixel data for which the Data Valid signal is ‘1’ for the first time.

Then, the same portion 24 writes, in the line direction, dst_sz worth of pixel data for which the Data Valid signal is ‘1.’

The same portion 24 repeats this row-by-row process as many times as the number of d_all_vsz lines.

This allows for all the rows of pixel data in all the divided areas to be mapped onto the output image and stored in the external storage section 11.

Executing a loop (step ST9)

The enlargement/reduction section 16 notifies the control section 13 when it completes the processing of the partial image.

The control section 13 determines whether all the divided areas of the input image have been processed.

If there is a divided area that has yet to be processed, the control section 13 sets the parameters of the next divided area in the enlargement/reduction section 16, causing the same section 16 to proceed with the processing (steps ST4 to ST8).

The control section 13 repeats the determination in step ST9 until there is no longer any divided area that has yet to be processed.

When all the divided areas of the input image have been processed, the control section 13 terminates the processing based on the determination made in step ST9.

### SUMMARY

As described above, in the present embodiment, the control section 13 calculates various parameters necessary for multi-pass scaling to proceed with multi-pass scaling.

More specifically, the control section 13 sets the parameters, necessary for multi-pass scaling of the divided area and obtained by the calculation, in the control registers of the enlargement/reduction section 16, instructs the same section 16 to proceed with the processing and waits for the completion of the multi-pass scaling.

The enlargement/reduction section 16 notifies the control section 13 of completion of multi-pass scaling using, for example, a enlarging or reducing end notification interrupt or multi-pass scaling completion status flag.

When notified of completion of the multi-pass scaling, the control section 13 repeats the above processing as many times as npass.

When the multi-pass scaling is complete for all the divided areas, the control section 13 terminates the multi-pass scaling.

Further, the present embodiment provides the following advantageous effects thanks to the multi-pass scaling described above used for enlarging or reducing an image.

First, in the present embodiment, an image is divided according to the storage capacity of the line memory 22 for enlarging or reducing.

This eliminates the need to increase the storage capacity of the line memory 22 even if the image size to be processed becomes larger, thus making it possible to enlarge or reduce the high quality digital image without changing the small storage capacity.

Moreover, in the present embodiment, the image is divided horizontally into a plurality of areas so that the partial image in each divided area is enlarged or reduced.

That is, in the present embodiment, the interpolation filter 23 proceeds with enlarging or reducing in the order in which the pixels are read into the line memory 22.

Therefore, in the present embodiments, enormously frequent switching (re-reading) of pixel data in the line memory 22 in proportion to the number of vertical taps unlike the sequential process does not occur.

In the present disclosure, it is unlikely that the number of times each piece of pixel data in each row of the input image is read may increase despite the fact that the pixel data is read on a plurality of separate occasions.

As a result, the present embodiment contributes to significantly reduced amount of data accessed in the external storage section 11 despite the fact that all the pixel data in each row of the input image is not read for processing, thus ensuring fast enlarging or reducing processing comparable to enlarging or reducing processing without dividing the image.

In the present embodiment, therefore, it is possible, for example, to connect an image processing section 98, i.e., a section for which a high data bandwidth separate from the enlargement/reduction section 16 is necessary, to the data bus 12 for efficient use of the bus system.

Further, because, in the present embodiment, the amount of data read and the number of times the data is read do not increase unlike the sequential process, it is unlikely that the processing may be stalled because of a wait for data to be read, thus providing fast processing speed comparable to using the line memory 22 having enough capacity to store the image.

Further, in the present embodiment, an overlapping area or areas are added to each of the divided areas so that the partial image with an overlapping area or areas is converted during processing of each of the divided areas.

Moreover, in the present embodiment, a phase (offset) is accurately set for each of the divided areas, accurately correcting the pixel positions in each of the divided areas.

In the present embodiment, therefore, the image is not discontinuous at the boundaries between the divided areas of the output image despite the fact that the image is divided into the plurality of areas for processing.

As a result, in the present embodiment, it is unlikely that the image quality may degrade because of the division of the image for processing. That is, the present embodiment provides an image with the same quality as that obtained by enlarging or reducing in one operation.

### 2. Second Embodiment

### [Configuration and Operation of Television Broadcasting Receiver]

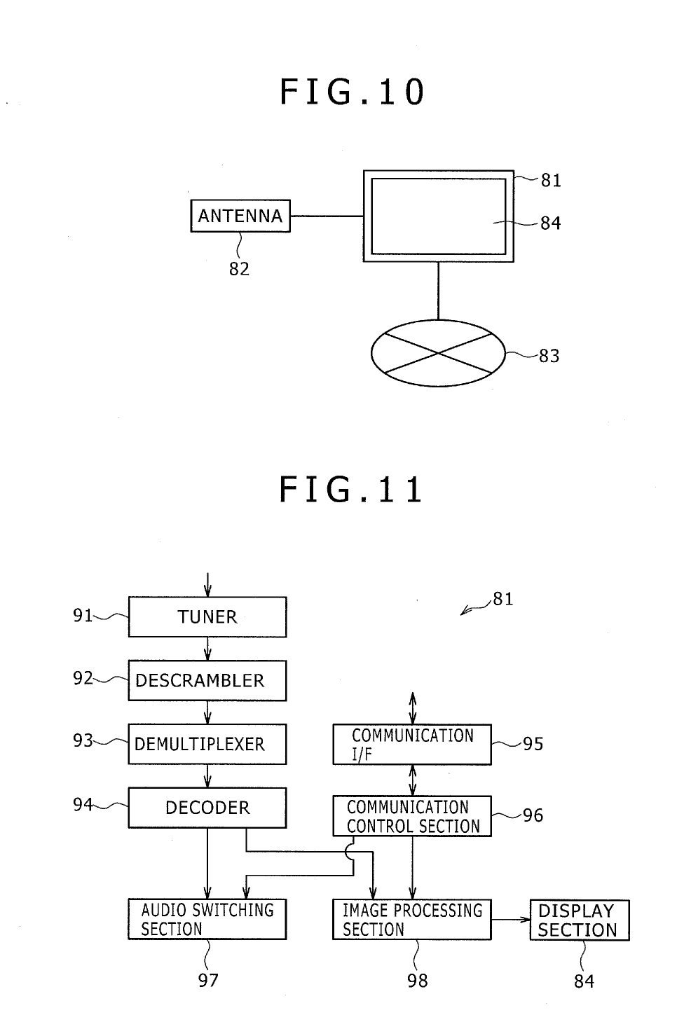

FIG. 10 is a schematic block diagram of electronic equipment according to a second embodiment of the present disclosure.

The electronic equipment shown in FIG. 10 is a television broadcasting receiver 81.

The television broadcasting receiver 81 is connected to an antenna 82 with a coaxial cable and connected to the Internet 83 with a communication cable.

The same receiver 81 generates a display image from a moving image received from broadcasting waves or a web page received from the Internet 83, thus displaying the display image on a display section 84.

FIG. 11 is a block diagram illustrating an example of a reception circuit of the television broadcasting receiver shown in FIG. 10.

The television broadcasting receiver 81 shown in FIG. 11 includes a tuner 91 connected to the antenna 82, a descrambler 92, demultiplexer 93 and decoder 94.

Further, the same receiver 81 includes a communication interface (I/F) 95 connected to the Internet 83 and a communication control section 96.

The decoder 94 and communication control section 96 are connected to an audio switching section 97 and image processing section 98.

The image processing section 98 processes a moving image included in broadcasting waves or a web page or moving image acquired from the Internet 83, outputting display data to the display section 84.

The image processing section 98 shown in FIG. 11 has the image converter 1 shown in FIG. 1.

This allows for the television broadcasting receiver 81 Shown in FIG. 11 to generate an output image by enlarging or reducing the received image and output display data of the output image to the display section 84.

As a result, the received image appears on the display section 84 at a desired size enlarged or reduced from the original size.

Although the above embodiments are preferred embodiments of the present disclosure, the present disclosure is not limited thereto and may be modified or altered in various ways without departing from the scope of the present disclosure.

In the second embodiment, for example, the image converter 1 shown in FIG. 1 is used in the television broadcasting receiver 81.

In addition to the above, the image converter 1 shown in FIG. 1 may be used, for example, in other pieces of electronic equipment such as computer device, mobile phone and personal digital assistant.

The present disclosure contains subject matter related to that disclosed in Japanese Priority Patent Application JP 2011-008598 filed in the Japan Patent Office on Jan. 19, 2011, the entire content of which is hereby incorporated by reference.

What is claimed is:

1. An image converter comprising:
an acquisition section adapted to acquire pixel data of a plurality of pixels that are defined in a matrix form in an image;
a storage section adapted to store the acquired pixel data; and
a conversion section adapted to enlarge or reduce an acquired input image into an output image by increasing or reducing the number of pixels making up the image using the pixel data stored in the storage section, wherein
the acquisition section reads pixel data of a plurality of pixels included in each row of the input image on a plurality of separate occasions, and
the conversion section performs enlarging or reducing processing to increase or reduce the number of pixels in the order in which the pixels are read into the storage section.

2. The image converter according to claim 1, wherein
the acquisition section reads the plurality of pixel data of the input image on a divided area-by-divided area basis with the input image divided into the plurality of areas in the row direction, and
the conversion section performs enlarging or reducing processing for each of the divided areas and repeats the enlarging or reducing processing as many times as the number of divided areas.

3. The image converter according to claim 1, wherein
the acquisition section acquires a plurality of rows of pixel data of the divided area successively on a row by row basis during processing of each of the divided areas, and
the conversion section generates a plurality of pixel data in each row of the output image based on a plurality of rows of pixel data stored in the storage section.

4. The image converter according to claim 1 further comprising:
a control section adapted to control the acquisition section and conversion section, wherein
the storage section has a given storage capacity, and
the control section determines the number of divisions of the image based on the storage capacity of the storage section, causes the acquisition section to read the input image for each of the divided areas into which the input image is divided by the number of divisions, and causes the conversion section to repeat. the enlarging or reducing processing for each of the divided areas read as many times as the number of divisions.

5. The image converter according to claim 4 further comprising:
an output section adapted to output, under control of the control section, pixel data of the divided areas processed by the conversion section, wherein
the output section outputs the plurality of pixel data of the divided areas processed by the conversion section on a divided area-by-divided area basis in the order in which the pixel data is processed.

6. The image converter according to claim 5, wherein
the output section controls the output of the pixel data in each of the divided areas generated by the conversion section so that, of the pixel data in each of the divided areas of the output image processed by the conversion section, the pixel data in one of the divided areas obtained by dividing the output image by the number of divisions is output, and so that the pixel data in an overlapping area or areas provided between each of the divided areas and its adjacent divided area or areas is not output.

7. The image converter according to claim 6, wherein
the acquisition section reads the image data in each of the divided areas on a row by row basis during processing of each of the divided areas,
the conversion section generates pixel data in each row of the divided area of the output image from a plurality of rows of pixel data in the divided area of the input image stored in the storage section, and
the output section outputs the pixel data in each of the divided areas, into which the output image is divided by the number of divisions, by counting, with a counter, the number of pixels in each row of the divided area generated by the conversion section, and controls the output of the pixel data in each of the divided areas of the output image generated by the conversion section so that the pixel data in the overlapping areas is not output.

8. The image converter according to claim 6, wherein
the conversion section generates each piece of pixel data of the output image based on a plurality of pixel data of the pixel in question of the input image, and
the control section causes the acquisition section to acquire a predetermined number of pieces of pixel data appropriate to the storage capacity of the storage section as pixel data in the overlapping areas when causing the acquisition section to acquire each row of the divided area of the input image.

9. The image converter according to claim 4, wherein
the control section causes the acquisition section to acquire an area larger than one of the divided areas obtained by dividing the input image by the number of divisions so that the overlapping area or areas are provided between each of the divided areas and its adjacent divided area or areas, and
the conversion section enlarges or reduces the divided area larger than one of the divided areas obtained by dividing the input image by the number of divisions.

10. The image converter according to claim 4, wherein
the control section defines the number of pixels obtained by subtracting the number of pixels in the overlapping areas on both sides of the divided area sandwiched by the overlapping areas of all the plurality of divided areas of the input image from the number of pixels that can be stored in the storage section per row as the maximum number of pixels in the row direction common to all the divided areas and determines the number of divisions in such a manner that each row of the acquired image is divided by the maximum numbers of pixels, and
the control section causes the acquisition section to acquire, as a divided area, an area combining one of the areas obtained by dividing the input image by the number of divisions and the overlapping area or areas of that area.

11. The image converter according to claim 4, wherein
the control section calculates a relative offset between boundary pixel strings in the divided areas of the input and output images, and
the conversion section uses the relative offset to calculate the pixel data in each of the divided areas of the output image.

12. The image converter according to claim 4, wherein
the control section determines whether it is necessary to divide an input image to be acquired prior to the acquisition of image data by the acquisition section, and
if it is not necessary to divide the input image, the control section causes the acquisition section to read the entire input image row by row, and causes the conversion section to enlarge or reduce the input image in one operation.

13. An image conversion method of an image converter, the image converter including an acquisition section adapted to acquire pixel data of a plurality of pixels that are defined in a matrix form in an image, a storage section adapted to store the acquired pixel data, and a conversion section adapted to enlarge or reduce an acquired input image into an output image by increasing or reducing the number of pixels making up the image using the pixel data stored in the storage section, the image conversion method comprising:
by the acquisition section, reading pixel data of a plurality of pixels included in each row of the input image on a plurality of separate occasions; and
by the conversion section, performing enlarging or reducing processing to increase or reduce the number of pixels in the order in which the pixels are read into the storage section.

14. A program causing a computer to serve as a control section of an image converter, the image converter including an acquisition section adapted to acquire pixel data of a plurality of pixels that are defined in a matrix form in an image, a storage section adapted to store the acquired pixel data, and a conversion section adapted to enlarge or reduce an acquired input image into an output image by increasing or reducing the number of pixels making up the image using the pixel data stored in the storage section, the control section adapted to control the acquisition section and conversion section, the program causing the computer to:
determine the number of divisions of an input image and a plurality of areas into which the input image is divided by the number of divisions;
cause the acquisition section to read pixel data of a plurality of pixels included in each row of the input image on a plurality of separate occasions; and
cause the conversion section to perform enlarging or reducing processing to increase or reduce the number of pixels in the order in which the pixels are read into the storage section in such a manner that enlarging or reducing processing is repeated in the plurality of divided areas as many times as the number of divisions.

15. Electronic equipment comprising:
an external memory adapted to store digital image data having pixel data of a plurality of pixels defined in a matrix form in an image; and
an image conversion section adapted to read a plurality of pixel data from the external memory for image enlarging or reducing, the image conversion section including
an acquisition section adapted to acquire pixel data from the external memory,
a storage section adapted to store the acquired pixel data, and
a conversion section adapted to enlarge or reduce an acquired input image into an output image by increasing or reducing the number of pixels making up the image using the pixel data stored in the storage section, wherein
the acquisition section reads pixel data of a plurality of pixels included in each row of the input image on a plurality of separate occasions, and wherein
the conversion section performs enlarging or reducing processing to increase or reduce the number of pixels in the order in which the pixels are read into the storage section.
